(19) United States
(12) Patent Application Publication
(10) Pub. No.: US 2016/0076915 A1
(43) Pub. Date: Mar. 17, 2016

(54) LIGHT GUIDE BODY FOR LIGHT EMITTING POINTER

(71) Applicant: CALSONIC KANSEI CORPORATION, Saitama-shi, Saitama (JP)

(72) Inventor: Kinya TAMURA, Saitama-shi, Saitama (JP)

(73) Assignee: CALSONIC KANSEI CORPORATION, Saitama-shi, Saitama (JP)

(21) Appl. No.: 14/787,843

(22) PCT Filed: Mar. 27, 2014
(86) PCT No.: PCT/JP2014/058958

§ 371 Date: Oct. 29, 2015

(30) Foreign Application Priority Data
May 17, 2013 (JP) 2013-104688

(51) Int. Cl. G01D 5/26; F21V 8/00

(52) U.S. Cl. CPC G01D 5/26; G02B 6/002; G02B 6/0038; G02B 6/0046

(57) ABSTRACT

A light guide body includes a light introduction member (12) and a light reflection member (11), and a side reflection surface (14) for reflecting introduced light to an opposite region which is on the opposite side across an opening (13) is formed on a side surface part of the light reflection member (11). A groove part for guiding the introduced light toward a direction of a light emitting pointer (24) is formed around the opening (13) in the light reflection member (11). The groove part includes a first groove part (P1) and a second groove part (P2) around the opening (13). The first groove part (P1) includes a plurality of grooves oriented in a direction almost orthogonal to the introduced light, and the second groove part (P2) includes a plurality of grooves having a predetermined angle relative to the grooves of the first groove part (P1).

### TECHNICAL FIELD

The present invention relates to a light guide body for light emitting pointer used when introducing light to a light emitting pointer used in an instrument for a vehicle and lighting up the light emitting pointer.

### BACKGROUND ART

Among pointers used in on-board instruments such as a speed indicator (a speed meter) and a revolution counter (a tachometer) of an engine, there is known a light emitting pointer that makes the pointer emit light by introducing light so as to improve visibility, like the pointers including the instruments described in Patent Literatures 1, 2.

In the above-mentioned Patent Literatures 1, 2, the light is supplied to the light emitting pointer by providing a plurality of LEDs (Light Emitting Diodes) in the vicinity of a root of a rotating shaft of the light emitting pointer. Since the light emitting pointer changes its deflection angle in accordance with a display amount at that time (for example, a vehicle speed in case of the speed meter), it is configured so as to provide the plurality of LEDs such that a fixed light quantity can be maintained even in a case where the angle of the deflection angle of the light emitting pointer is changed.

### CITATION LIST

### Patent Literature

Patent Literature 1: Japanese Patent Laid-Open Publication No. 2008-215883

Patent Literature 2: Japanese Patent No. 4809107

### SUMMARY OF INVENTION

### Technical Problem

As described above, since in the prior art disclosed in Patent Literatures 1, 2, since the plurality of LEDs is provided in order to make the pointer emit light always with the fixed light quantity regardless of the deflection angle of the pointer, such problems have arisen that not only it is increased in cost, but also electric wiring becomes complicated, and further a great deal of installation space becomes necessary.

The present invention has been made in order to solve such conventional problems and an object thereof is to provide a light guide body for pointer capable of making the light emitting pointer uniformly emit light regardless of the angle of the pointer by using one LED.

### Solution to Problem

A light guide body for light emitting pointer of the present invention is formed of a light transmissible material and is adapted to introduce light emitted from a light source into the light emitting pointer of the instrument for vehicle and to make the light emitting pointer emit light. In order to attain the above-mentioned object, the light guide body for light emitting pointer of the present invention includes: a light introduction member configured to introduce the light emitted from the light source; and a light reflection member having a flat-plate shape, having an opening for inserting a rotating shaft of the light emitting pointer formed in a central part, and configured to reflect the introduced light introduced by the light introduction member toward a direction of the light emitting pointer, wherein a linearly formed side reflection surface for reflecting the introduced light to an opposite region which is on the opposite side across the opening is formed on a side surface part of the light reflection member, and further, a groove part for reflecting the introduced light in a direction almost orthogonal to a front surface of the light reflection member to guide the reflected light toward the direction of the light emitting pointer is formed around the opening in the light reflection member, and wherein the groove part includes a first groove part formed in a region around the opening except the opposite region and including a plurality of grooves oriented in a direction almost orthogonal to the introduced light, and a second groove part formed in the opposite region and including a plurality of grooves having a predetermined angle relative to the grooves of the first groove part.

In the light guide body for light emitting pointer of the present invention, preferably, the light reflection member is formed to be thinner as it goes away from the opening, in the opposite region.

In the light guide body for light emitting pointer of the present invention, preferably, the grooves of the second groove part are formed to be deeper as the positions of the grooves of the second groove part are nearer to the central part.

In the light guide body for light emitting pointer of the present invention, preferably, the grooves of the second groove part are formed almost in parallel with a direction in which the introduced light is introduced.

In the light guide body for light emitting pointer of the present invention, preferably, the grooves of the second groove part are formed toward a direction almost orthogonal to the light reflected by the side reflection surface.

In the light guide body for light emitting pointer of the present invention, preferably, the grooves of the second groove part are formed radially outward from the opening.

### BRIEF DESCRIPTION OF DRAWINGS

FIG. 1 is a perspective view showing a configuration of a light guide body for pointer according to one embodiment of the present invention.

FIG. 2 is a perspective view showing a configuration of an instrument for vehicle with the light guide body for pointer according to one embodiment of the present invention being loaded.

FIG. 3 is a side surface view showing the configuration of the instrument for vehicle with the light guide body for pointer according to one embodiment of the present invention being loaded.

FIG. 4(a) is a plan view of the light guide body for pointer according to one embodiment of the present invention and FIG. 4(b) is a side surface view of the light guide body for pointer according to one embodiment of the present invention.

FIG. 5(a) is a bottom surface view of the light guide body for pointer according to one embodiment of the present invention, and FIG. 5(b) is a side surface view viewed from a “B” direction shown in FIG. 5(a).

FIG. 6 is a bottom surface view of a light guide body for pointer according to a first modified example of the present invention.

FIG. 7 is a bottom surface view of a light guide body for pointer according to a second modified example of the present invention.

FIG. 8(a) is an explanatory diagram of a first groove part of the light guide body for pointer according to one embodiment of the present invention, and FIG. 8(b) is an explanatory diagram of a second groove part of the light guide body for pointer according to one embodiment of the present invention.

FIG. 9 is an explanatory diagram showing a conventional light guide body for pointer.

### DESCRIPTION OF EMBODIMENTS

In the following, embodiments of the present invention will be described on the basis of the drawings.

### Description of One Embodiment of the Present Invention

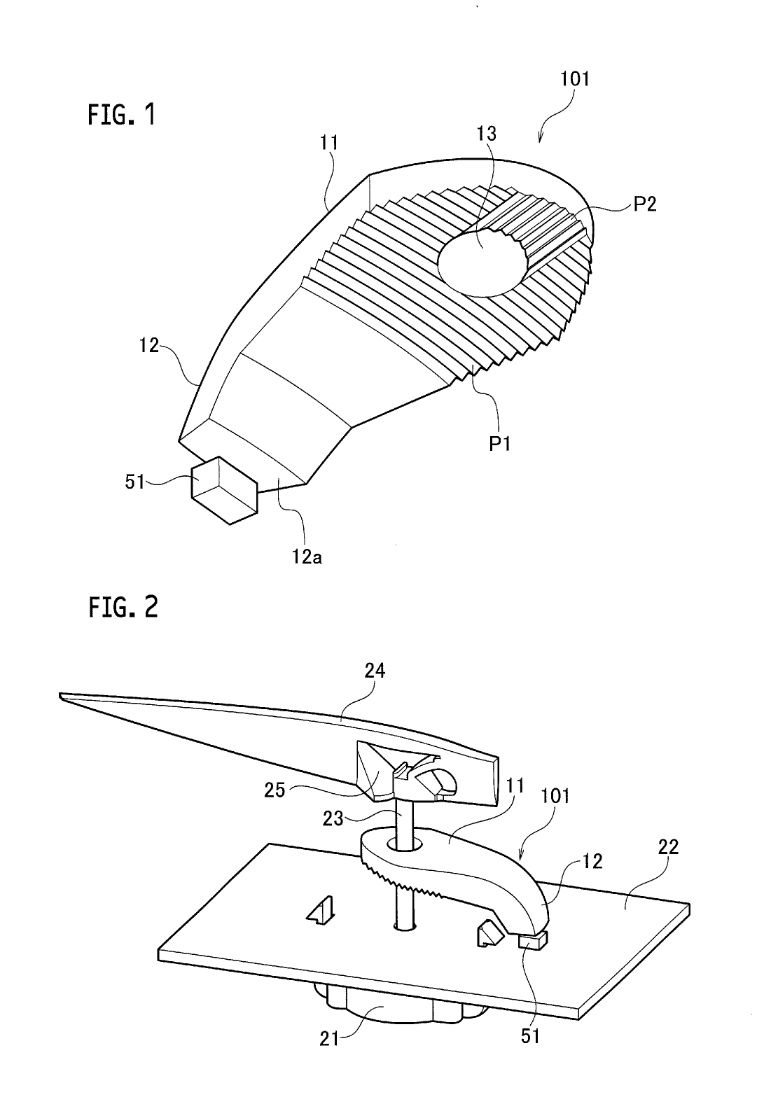

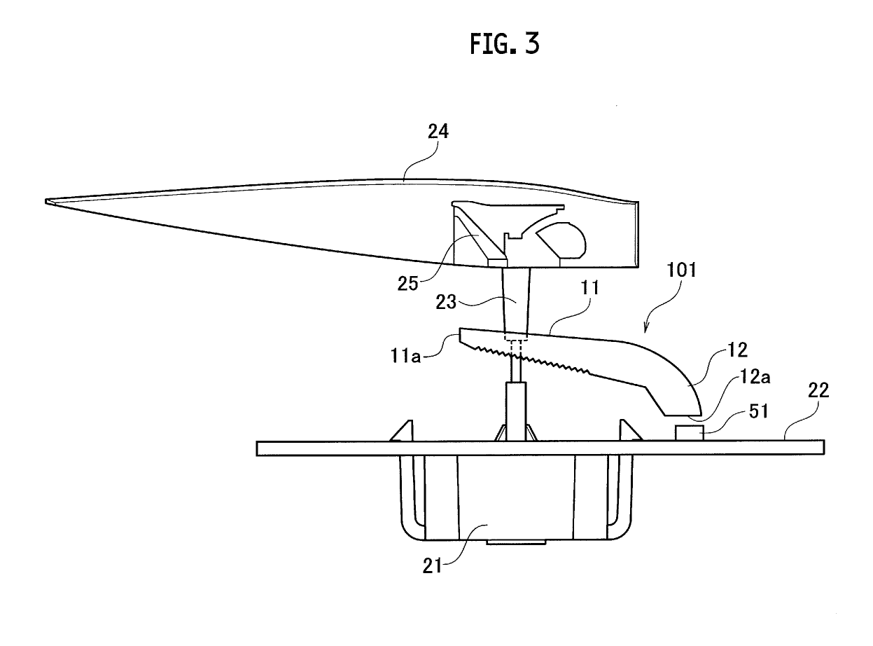

FIG. 1 is a perspective view showing a configuration when viewing a light guide body for pointer 101 according to one embodiment of the present invention obliquely from below. In addition, FIG. 2 is a perspective view showing a situation when this light guide body for pointer 101 is installed, and FIG. 3 is a side surface view of the same.

As shown in FIG. 1, the light guide body for pointer 101 is configured by a light reflection member 11 having a flat-pate shape, and a light introduction member 12 which is bent at an almost right angle relative to the light reflection member 11. Then, the light guide body for pointer 101 is formed of a light transmissible resinous material (a light transmissible material) such as acryl or polycarbonate.

In addition, an end surface 12a of the light introduction member 12 is arranged so as to face an LED (a light source) 51. When the LED 51 is turned on, this light is introduced by the light introduction member 12, the light (introduced light) which has been introduced is introduced into the light reflection member 11. In the light reflection member 11, a circular opening 13 is bored in the center and, further, a plurality of groove parts is formed on the lower surface side of the light reflection member 11. The groove part is configured to reflect the light which has been introduced into the light reflection member 11 in a direction almost orthogonal to a front surface of the light reflection member 11 and guide it to the side of a light emitting pointer 24, and includes a first groove part P1 and a second groove part P2 as shown in FIG. 1.

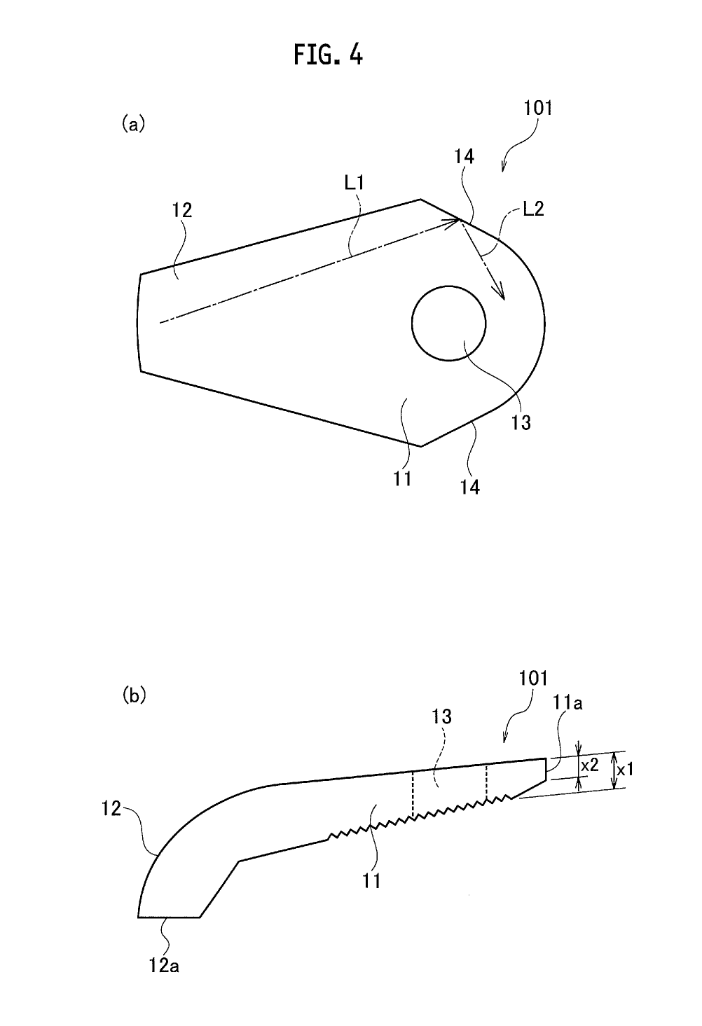

Further, FIG. 4(a) is a plan view of the light guide body for pointer 101 according to the present embodiment and FIG. 4(b) shows a side surface view of the same. As shown in the drawings, a side in the vicinity of a leading end part 11a of the light reflection member 11 is made as a linearly formed side reflection surface 14. While in the conventional light guide body for pointer, a side edge part of a light reflection member 111 is formed into an arc shape which is concentric with an opening 113 as shown in FIG. 9, in the light guide body for pointer 101 according to the present embodiment, it is formed into the linear shape.

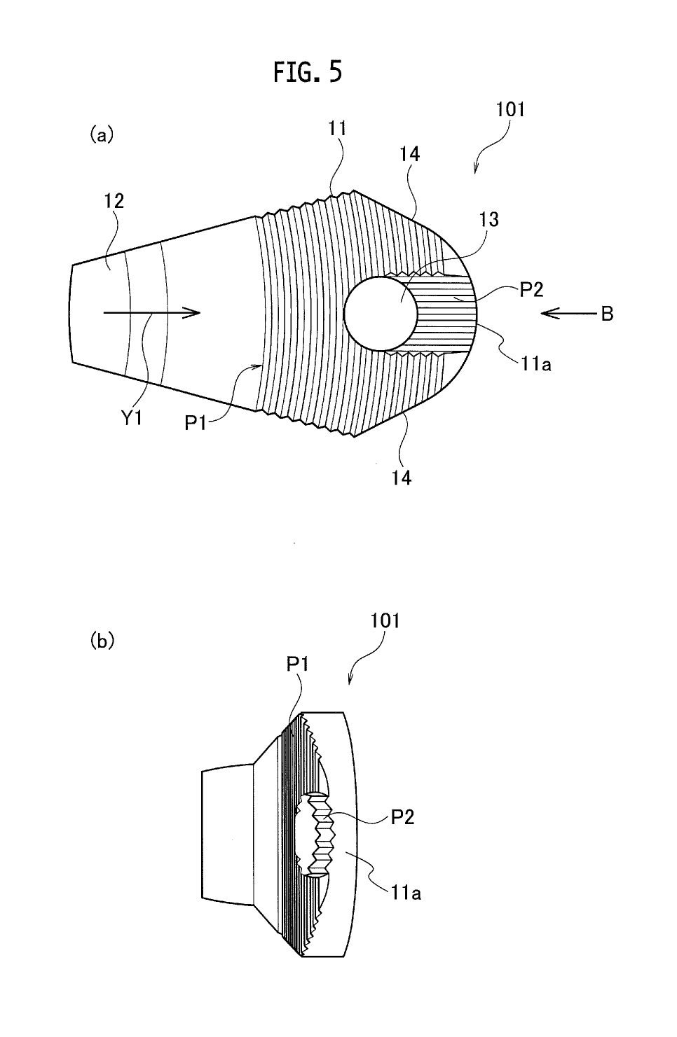

In addition, FIG. 5(a) is a bottom surface view of the light guide body for pointer 101 according to the present embodiment, and FIG. 5(b) shows a side surface view viewed from a “B” direction shown in FIG. 5(a). As shown in FIG. 5(a) and FIG. 5(b), the first groove part P1 including a plurality of arc-shaped grooves oriented in a direction almost orthogonal to a light introduction direction (a direction of Y1 shown in FIG. 5(a)) is formed in the vicinity of the opening 13 in the light reflection member 11. Further, the second groove part P2 including a plurality of grooves oriented in a direction (forming a predetermined angle relative to the grooves configuring the first groove part P1) almost parallel with the light introduction direction Y1 is formed in a region which is hidden behind the opening 13 viewed from the light introduction direction Y1, that is, a region (an opposite region) which is on the opposite side across the opening 13 relative to the light introduction side. The plurality of grooves which has been dug out in the first groove part P1, and the second groove part P2 is each configured by a face forming an angle of almost 45° relative to a horizontal direction (a direction vertical to an axial direction of the circular opening 13, or a direction vertical to a later described rotating shaft 23). Accordingly, when the introduced light which has been introduced from the horizontal direction is emitted to the first groove part P1, or the second groove part P2, this introduced light is reflected on the face forming the angle of almost 45° relative to the horizontal direction, and reflected in a perpendicular direction (the axial direction of the circular opening 13, or the direction of the later described rotating shaft 23). That is, the light is to be reflected upward (a direction of a reflection surface 25 of the light emitting pointer 24) shown in FIG. 2 and FIG. 3.

The light reflection member 11 is formed integrally with the light introduction member 12 to configure the light guide body for pointer 101, and is formed of the same light transmissible resinous material as the light guide body for pointer 101. A refractive index of the light transmissible resinous material which is the material of the light guide body for pointer 101 is larger than a refractive index of a medium which is present outside the light guide body for pointer 101 such as air or vacuum so as to meet a total reflection condition for reflecting the light which has been introduced into the light guide body for pointer 101 by means of the light introduction member 12 by the reflection surface. In addition, an incidence angle (an angle between a perpendicular line of a boundary surface and a progressive direction of light) of the light on the reflection surface is configured to be an angle larger than a critical angle at which total reflection occurs.

For example, in a case where the light transmissible resinous material is polycarbonate, since the refractive index is about 1.58, the critical angle reaches about 40°. Therefore, in a case where the incidence angle is almost 45°, the introduced light reflects in the light reflection member 11 by total reflection.

As shown in FIG. 3 and FIG. 4(b), the leading end part 11a of the light guide body for pointer 101 is formed to be gradually thinner toward the leading end side. That is, a relation between thicknesses x1 and x2 shown in FIG. 4(b) is set to x2<x1.

In addition, as shown in FIG. 2 and FIG. 3, the light guide body for pointer 101 is fixed to a substrate 22 by a support member or the like not illustrated. In this occasion, as shown in FIG. 2 and FIG. 3, a face of the light reflection member 11 is arranged so as to be almost side by side with the substrate 22. Further, a stepper motor 21 is attached to the back surface side of the substrate 22, the rotating shaft 23 of the stepper motor 21 passes through the substrate 22 and is inserted into the opening 13 in the light guide body for pointer 101. The light emitting pointer 24 is connected to a leading end part of the rotating shaft 23. The light emitting pointer 24 is a pointer used, for example, in the on-board instrument for vehicle such as the speed meter and the tachometer. Accordingly, the stepper motor 21 rotates in accordance with a display amount (a display speed in case of the speed meter) and the light emitting pointer 24 is to rotate to a desired angle in conjunction with this.

The light emitting pointer 24 is configured by a light transmissive member and a hot stamp is formed on a bottom surface thereof. Further, the reflection surface 25 which forms an angle of almost 45° relative to the rotating shaft 23 is provided in the vicinity of a coupling part of the light emitting pointer 24 with the rotating shaft 23. Accordingly, light to be emitted toward above the light reflection member 11 is reflected by the reflection surface 25, this reflected light is diffused all over the light emitting pointer 24 configured by the light transmissive member, and further since the hot stamp is formed on the bottom surface, the entire of the light emitting pointer 24 is to be lit up.

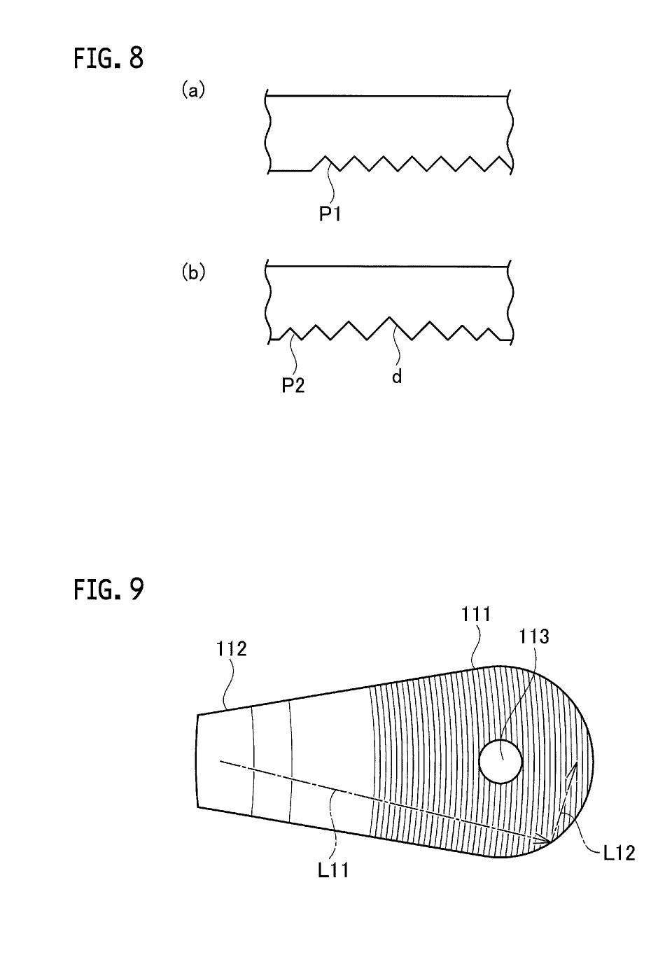

FIG. 8(a) and FIG. 8(b) are explanatory diagrams (in each of the first groove part P1 and the second groove part P2, the explanatory diagram corresponding to a section of a face forming an almost right angle together with a direction in which the groove extends) showing the shapes of the first groove part P1 and the second groove part P2. As shown in FIG. 8(a), a plurality of grooves configured by faces forming angles of almost 45° relative to the horizontal direction is formed in the first groove part P1 and depths of the grooves are made the same as one another. In addition, as shown in FIG. 8(b), a plurality of grooves configured by the faces forming the angles of almost 45° relative to the horizontal direction is formed in the second groove part P2. The grooves in the second groove part P2 are formed to be deeper as the positions of the grooves are nearer to a central part of the second groove part P2. Incidentally, assuming a direction vertical to the light introduction direction Y1 and the perpendicular direction as a width direction, the central part of the second groove part P2 indicates a center line relative to the width of the second groove part P2 or a linear region. In FIG. 8(b), a groove designated by a symbol d (a groove located on the central part of the second groove part P2) is formed deepest. The grooves of the second groove part P2 are formed to be deeper as the positions of the grooves are closer to the central part.

Next, an action of the light guide body for pointer 101 according to the present embodiment configured as mentioned above will be described. As shown in FIGS. 1 to 3, when the LED 51 which has been arranged so as to face the end surface 12a of the light introduction member 12 is turned on, the light emitted from the LED 51 is introduced into the light reflection member 11 via the light introduction member 12. The light (the introduced light) which has been introduced into the light reflection member 11 is to be emitted in the direction of the light introduction direction Y1 shown in FIG. 5(a), this introduced light is emitted to the first groove part P1 formed in the bottom surface of the light reflection member 11, is reflected by the grooves of the first groove part P1 and turns to light oriented in the perpendicular direction. That is, it turns to the light oriented toward the light emitting pointer 24 shown in FIG. 3.

In this occasion, the introduced light does not directly reach a region hidden behind the opening 13 viewed from the light introduction direction Y1, that is, the region (the opposite region: the region which is on the right side of the opening 13 shown in FIG. 5(a)) which is on the opposite side to the light introduction side across the opening 13 due to the presence of the rotating shaft 23 (see FIG. 3) to be inserted into the opening 13. However, as shown in FIG. 4(a), since the linear side reflection surface 14 is formed on the side surface part of the light reflection member 11, the introduced light emitted from the direction of a route L1 is reflected by the side reflection surface 14 and is emitted in the direction of a route L2, this introduced light is to be emitted to the second groove part P2 shown in FIG. 5(a). Accordingly, the light is reflected by the grooves of the second groove part P2 and is emitted toward the perpendicular direction (the direction of the reflection surface 25 of the light emitting pointer 24) of the light reflection member 11.

From the above-mentioned matter, the light emitted from the LED 51 is introduced into the light guide body for pointer 101 by the light introduction member 12 and further is reflected upward by the first groove part P1. In addition, part of the light which has been introduced into the light guide body for pointer 101 is reflected by the side reflection surface 14, is oriented toward the second groove part P2 and is reflected upward by the second groove part P2. Accordingly, in the region around the opening 13, the light is to be emitted upward almost uniformly.

That is, although in the prior art, as shown in FIG. 9, since light which is incident through a light introduction member 112 and introduced into the light reflection member 111 is sent from a route L11 to a direction of a route L12 by being reflected by an end part, this light was not able to be effectively emitted to the light emitting pointer side, but in the present embodiment, this light can be effectively utilized.

Accordingly, even in a case where the light emitting pointer 24 shown in FIG. 2 and FIG. 3 is present at any angle, the light of an almost fixed quantity is to be always incident upon the reflection surface 25 and it is possible to light up the light emitting pointer 24 with almost the same brightness.

In this way, in the light guide body for pointer 101 according to the present embodiment, the first groove part P1 including the plurality of grooves oriented in the direction almost orthogonal to the light introduction direction is formed around the opening 13 for inserting the rotating shaft 23. In addition, the side surface part of the light reflection member 11 is made as the linear side reflection surface 14, and further the second groove part P2 including the plurality of grooves oriented in the direction almost parallel with the light introduction direction is formed in the region (the opposite region) which is on the opposite side to the light introduction side across the opening 13. That is, the second groove part P2 having an extending direction which forms a predetermined angle relative to an extending direction of the grooves which configure the first groove part P1 is formed in the opposite region. Accordingly, the introduced light to be introduced through the light introduction member 12 into the light reflection member 11 is reflected upward by the first groove part P1. In addition, in the opposite region, the introduced light is reflected by the side reflection surface 14 and is further reflected upward by the second groove part P2.

Accordingly, the light is to be reflected upward almost uniformly around the opening 13, the quantity of light to be introduced by the reflection surface 25 can be made fixed regardless of which angle the angle of the light emitting pointer 24 is. Therefore, the light emitting pointer 24 can be lit up always with the same brightness by using one LED 51. As a result, there is no need to provide the plurality of light sources as in the prior art, the installation space can be reduced, and cost reduction can be promoted. In addition, the electric wiring can be simplified.

Further, since the leading end part 11a of the light reflection member 11 is formed to be gradually thinner as it goes away from the opening 13 (as it goes toward the leading end of the light reflection member 11 (made to be x2<x1 in FIG. 4(b)), the quantity of light to be reflected can be made uniform and the brightness can be made fixed regardless of the position in the opposite region.

Further, as described in FIG. 8(b), since the second groove part P2 is formed to be deeper toward the central part, the quantity of reflected light on the central part which the light is more difficult to reach can be increased and it becomes possible to make the quantity of light to be reflected more uniform.

### Description of Modified Examples of the Present Invention

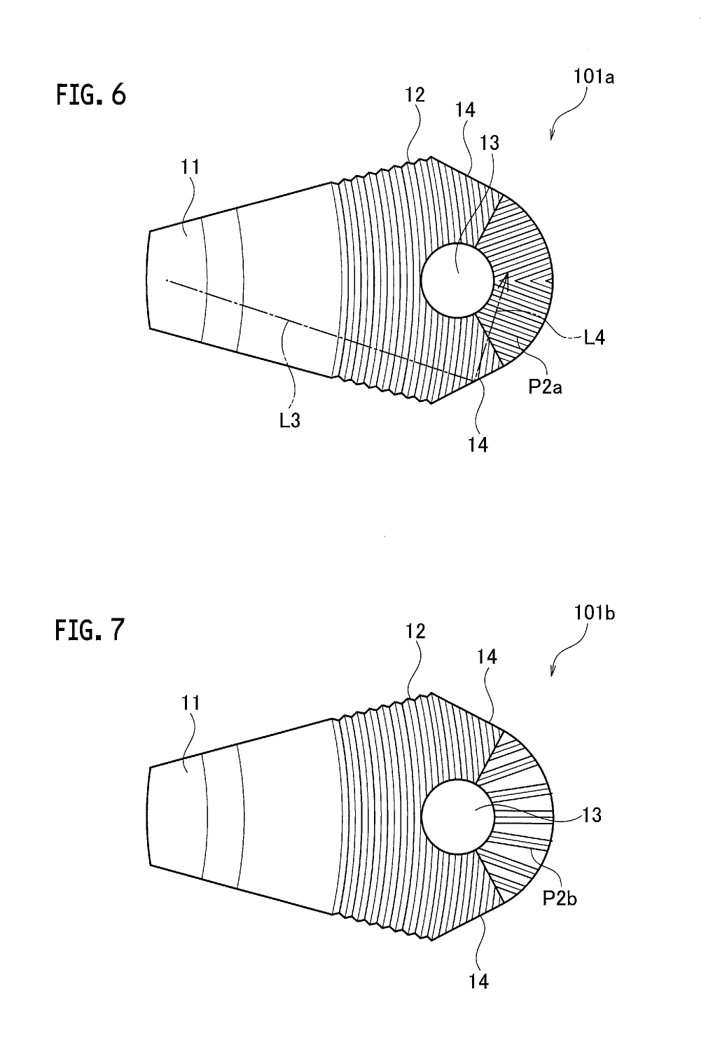

Next, modified examples of the above-mentioned embodiment will be described. FIG. 6 is a bottom surface view showing a configuration of a light guide body for pointer 101a according to a first modified example. As shown in the drawing, in the first modified example, a second groove part P2a is formed in the region (the opposite region) which is on the opposite side to the light introduction side across the opening 13 in a direction in which light is introduced. A plurality of grooves which configures the second groove part P2a is divided into a group including a plurality of grooves P2aR located on one side of a boundary and a group including a plurality of grooves P2aL located on the other side of the boundary across the boundary with the central part of the second groove part P2a being defined as the boundary. Although the extending directions of the grooves belonging to the same group are oriented in the same direction having a predetermined angle relative to the boundary, the extending directions of the grooves belonging to mutually different groups are oriented in mutually different directions. That is, while in the aforementioned first embodiment, the second groove part P2 (see FIG. 5(a)) including the grooves which are almost parallel with the light introduction direction is formed, in the first modified example, it is different in the point that the second groove part P2a including the grooves oriented in two directions is formed.

In the light guide body for pointer 101a according to the so configured first modified example, light reflected by the side reflection surface 14 is efficiently reflected upward (in the direction of the reflection surface 25 of the light emitting pointer 24) by the second groove part P2a. Specifically, the light which has been introduced along a route L3 is emitted in a direction of a route L4 by being reflected by the side reflection surface 14, and the reflected light is emitted to the second groove part P2a. Since the plurality of grooves which configures the second groove part P2a is formed such that the progressive direction of the light reflected by the side reflection surface 14 is almost orthogonal to the groove extending direction, the light emitted to the second groove part P2a is efficiently reflected toward the direction of the reflection surface 25 of the light emitting pointer 24. That is, in the light guide body for pointer 101a according to the so configured first modified example, the reflection efficiency can be improved and it becomes possible to make the light quantity more uniform.

FIG. 7 is a bottom surface view showing a configuration of a light guide body for pointer 101b according to a second modified example. As shown in the drawing, in the second modified example, a second groove part P2b including a plurality of grooves which radially spreads outward centering on the opening 13 is formed in the region (the opposite region) which is on the opposite side to the light introduction side across the opening 13 in the direction in which the light is introduced. Then, in the light guide body for pointer 101b according to the so configured second modified example, the plurality of grooves which configures the second groove part P2b is formed such that the progressive direction of the light which has been reflected by the side reflection surface 14 and the extending direction of the grooves form an angle which is approximate to an almost right angle by radially spreading outward centering on the opening 13, the light emitted to the second groove part P2b is efficiently reflected toward the direction of the reflection surface 25 of the light emitting pointer 24. That is, in the light guide body for pointer 101b according to the so configured second modified example, the reflection efficiency can be improved and it becomes possible to make the light quantity more uniform.

Although in the foregoing embodiment and modified examples of the present invention, the light reflection member 11 has been made so as to reflect the introduced light by total reflection, also the one utilizing another physical phenomenon may be favorable as long as it is the one which performs reflection similarly. For example, in the surfaces of the light reflection member 11, metal may be attached to a part which is desired to act as the reflection surface and may be finished so as to work as a mirror surface relative to the introduced light.

Although, in the foregoing, the embodiments of the present invention have been described, these embodiments are merely illustrations which have been described for easy understanding of the present invention and the present invention is not limited to the embodiments concerned. The technical scope of the present invention includes, not limited to specific technical matters described in the above-mentioned embodiment, also various alterations, modifications, alternative technologies and so forth which can be readily derived therefrom.

The present application claims the priority based on Japanese Patent Application No. 2013-104688 filed on May 17, 2013 and the entire content of the present application is herein incorporated by reference.

### INDUSTRIAL APPLICABILITY

Since the linear side reflection surface is formed on the side surface part of the light reflection member, the light guide body for pointer according to the present invention can send the introduced light which has been introduced by the light introduction member to the opposite region which is on the opposite side of the opening. Further, since the second groove part having the predetermined angle relative to the first groove part is formed in this opposite region, the introduced light sent to the opposite region is efficiently reflected by the second groove part and is emitted in the perpendicular direction. Accordingly, since the light can be reflected uniformly all around the opening and emitted to the light emitting pointer side, it can be utilized for making the light emitting pointer uniformly emit light regardless of the angle of the pointer.

### REFERENCE SIGNS LIST

11 light reflection member

11a leading end part

12 light introduction member

12a end surface

13 opening

14 side reflection surface

21 stepper motor

22 substrate

23 rotating shaft

24 light emitting pointer

25 reflection surface

51 LED

101, 101a, 101b light guide body for pointer

P1 first groove part

P2, P2a, P2b second groove part

1. A light guide body for light emitting pointer configured to introduce light emitted from a light source into a light emitting pointer of an instrument for vehicle so as to make the light emitting pointer emit light and formed of a light transmissible material, the light guide body comprising:
a light introduction member configured to introduce the light emitted from the light source; and
a light reflection member having a flat-plate shape, having an opening for inserting a rotating shaft of the light emitting pointer formed in a central part, and configured to reflect the introduced light introduced by the light introduction member toward a direction of the light emitting pointer, wherein
a linearly formed side reflection surface for reflecting the introduced light to an opposite region which is on the opposite side across the opening is formed on a side surface part of the light reflection member, and
further, a groove part for reflecting the introduced light in a direction almost orthogonal to a front surface of the light reflection member to guide the reflected light toward the direction of the light emitting pointer is formed around the opening in the light reflection member, and wherein
the groove part includes
a first groove part formed in a region around the opening except the opposite region and including a plurality of grooves oriented in a direction almost orthogonal to the introduced light, and
a second groove part formed in the opposite region and including a plurality of grooves having a predetermined angle relative to the grooves of the first groove part.

2. The light guide body for light emitting pointer according to claim 1, wherein
the light reflection member is formed to be thinner as it goes away from the opening, in the opposite region.

3. The light guide body for light emitting pointer according to claim 1, wherein
the grooves of the second groove part are formed to be deeper as the positions of the grooves of the second groove part are nearer to the central part.

4. The light guide body for light emitting pointer according to claim 1, wherein
the grooves of the second groove part are formed almost in parallel with a direction in which the introduced light is introduced.

5. The light guide body for light emitting pointer according to claim 1, wherein
the grooves of the second groove part are formed toward a direction almost orthogonal to the light reflected by the side reflection surface.

6. The light guide body for light emitting pointer according to claim 1, wherein
the grooves of the second groove part are formed radially outward from the opening.
